(19) United States
(12) Patent Application Publication
(10) Pub. No.: US 2017/0368386 A1
(43) Pub. Date: Dec. 28, 2017

(54) Fall Protection and Buffering Device with Compensating Arrangement

(71) Applicant: Fang-Kuan Wu, Taichung City (TW)

(72) Inventor: Fang-Kuan Wu, Taichung City (TW)

(21) Appl. No.: 15/193,122

(22) Filed: Jun. 27, 2016

(51) Int. Cl. A62B 35/00

(52) U.S. Cl. CPC A62B 35/0043

(57) ABSTRACT

A fall protection and buffering device includes a retaining strip, a buffer strip, and a compensating arrangement. The buffer strip includes first and second textile layers overlappedly affixed with each other. The first and second textile layers are separated at one end of the buffer strip at the first strip section thereof and are affixed to top and bottom ends of the retaining strip respectively. The first and second textile layers are torn from each other sequentially along the buffer strip in response to a falling force applied to the retaining strip. The compensating arrangement has at least a binding section provided at the retaining strip to fasten the retaining strip in a folded state, such that the binding section compensates a tensile strength of the buffer strip for resisting a tearing between the first and second textile layers.

### NOTICE OF COPYRIGHT

A portion of the disclosure of this patent document contains material which is subject to copyright protection. The copyright owner has no objection to any reproduction by anyone of the patent disclosure, as it appears in the United States Patent and Trademark Office patent files or records, but otherwise reserves all copyright rights whatsoever.

### BACKGROUND OF THE PRESENT INVENTION

### Field of Invention

The present invention provides a fall protection and buffering device with a compensating arrangement that reduces the tensile strength of a buffer strip and provides multiple compensating structures on a retaining strip to meet the current standards of ANSI Z359.14 of the United States and EN360 of European Union.

### Description of Related Arts

In the circumstances that operation constructions at height to mitigate the effects of gravity and falling, such as rock climbing, mountaineering, construction, etc., there must be compensated fall protection suspension device for safety purpose.

However, prior inventions, such as Taiwan Pat. No. 091200907: “Improved anti-fall safety belt,” No. 101210703: “High altitude safety rope,” No. 099202772: “Safety work clothing and its buffer packets,” and No. 099104089: “Safe workwear with cushion bag,” all fail in the marginal test according to the current standards of ANSI Z359.14 of the United States and EN360 of European Union. The marginal test is also called “SRL-Leading Edge (SRL-LE),” where the test cables of the prior inventions are cut off by the R0.13 test steel plate and fail to ensure a reliable protection. As a result, these prior products are also having difficulty in remaining on the shelves.

Because of this, the present inventor has elaborately conducted his research and development and eventually come up with the present invention.

### SUMMARY OF THE PRESENT INVENTION

The present invention provides a fall protection suspension device which comprises a retaining strip, a buffer strip, and a compensating arrangement.

The retaining strip has a predetermined length between a top end and a bottom end.

The buffer strip comprises a first textile layer and a second textile layer overlappedly affixed with each other. The first textile layer and the second textile layer are separated and individually extended from one end of the buffer strip. The first textile layer at the end of the buffer strip is affixed to the top end of the retaining strip. The second textile layer at the end of the buffer strip is affixed to the bottom end of the retaining strip. An opening separated by the first textile layer and the second textile layer at the buffer strip faces toward the retaining strip. Accordingly, the falling force will tear the first textile layer and second textile layer away from each other to sequentially separate the first textile layer and second textile layer from one end of the retaining strip to another end thereof.

The compensating arrangement that fastens the retaining strip in a folded state, wherein the compensating arrangement has at least a binding section provided at the retaining strip to fasten the retaining strip in the folded state, such that the binding section compensates a tensile strength of the buffer strip for resisting a tearing between the first textile layer and the second textile layer.

Therefore, the present invention is able to improve on the single side tearing configuration of the buffer strip of the conventional device in response to a falling scenario. Testing shows that product based on the present invention meets the requirements of the marginal test, the SRL-Leading Edge (SRL-LE), according to the standards of ANSI Z359.14 of the United States and EN360 of European Union, which further reinforces its safety protection function.

Still further objects and advantages will become apparent from a consideration of the ensuing description and drawings.

These and other objectives, features, and advantages of the present invention will become apparent from the following detailed description, the accompanying drawings, and the appended claims.

### BRIEF DESCRIPTION OF THE DRAWINGS

FIG. 1 is a perspective view of a fall protection and buffering device in a folded state according to a preferred embodiment of the present invention.

FIG. 2 is a perspective view of the fall protection and buffering device in an unfolded state according to the preferred embodiment of the present invention.

FIGS. 3 and 4 are perspective views of the first textile layer and the second textile layer of the buffer strip being torn according to the preferred embodiment of the present invention.

FIG. 5 illustrates a first alternative mode of the fall protection and buffering device according to the preferred embodiment of the present invention.

FIG. 6 illustrates a second alternative mode of the fall protection and buffering device according to the preferred embodiment of the present invention.

### DETAILED DESCRIPTION OF THE PREFERRED EMBODIMENT

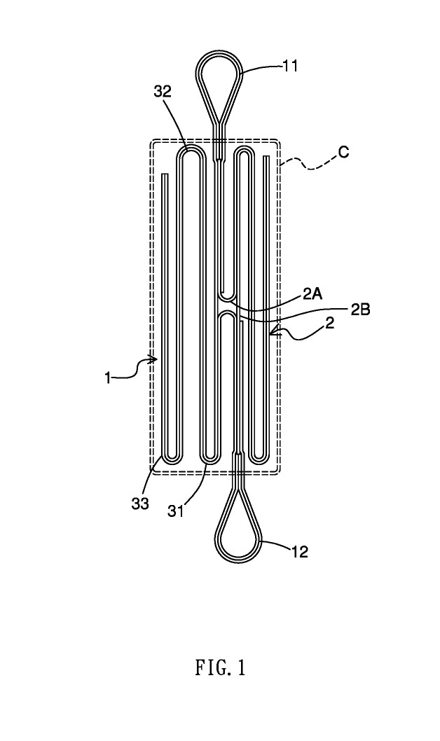

Referring to FIGS. 1 to 4, the present invention comprises a retaining strip 1, a buffer strip 2, and a compensating arrangement.

The retaining strip 1, which has a predetermined length between a top end and a bottom end, comprises an upper connection unit 11 extended from the top end and a lower connection unit 12. The upper connection unit 11 of the retaining strip 1 is adapted for coupling with an anti-falling device (not shown in the figures) via the retaining ring. The lower connection unit 12 of the retaining strip 1 is adapted to couple with a cable (not shown in the figures) to fasten therewith, so as to connect to the safety belt to the user via the cable.

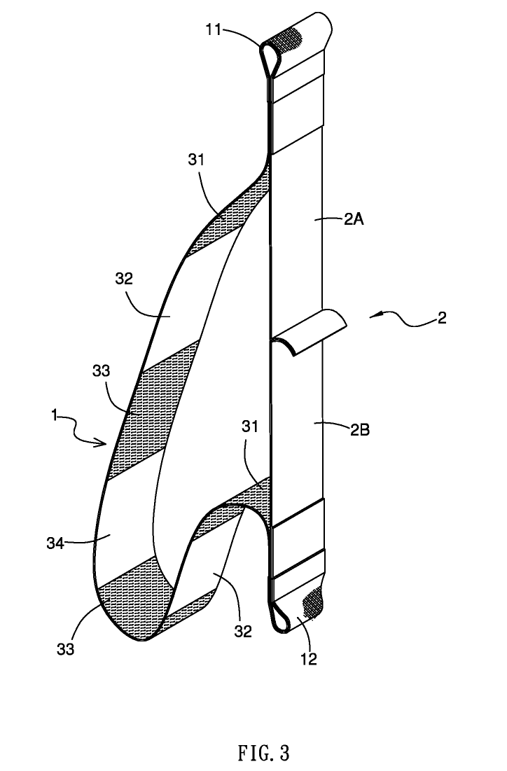

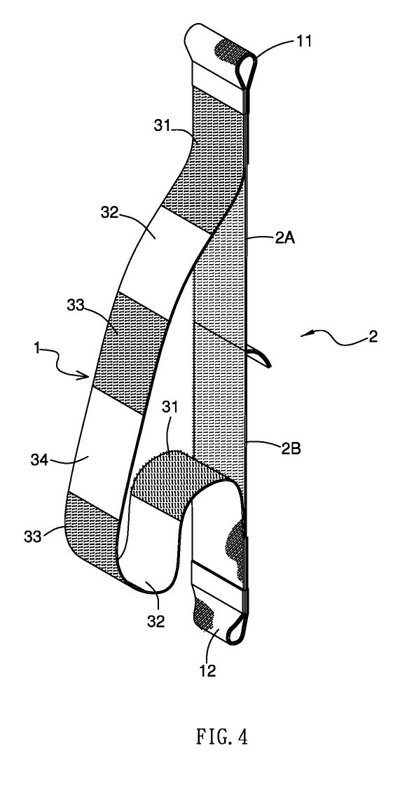

The buffer strip 2 has a predetermined length between two ends, wherein the length of the buffer strip 2 is not longer than the length of the retaining strip 1. The buffer strip 2 comprises a first textile layer 2A and a second textile layer 2B overlappedly affixed with each other. The first textile layer 2A and the second textile layer 2B can also be sewed into one piece with at least a stitching line which preferably formed with a zigzag configuration. Alternatively, the yarns of the first textile layer 2A and the second textile layer 2B can be intertwined with each other to form a one piece weaving structure. Accordingly, the first textile layer 2A and the second textile layer 2B are separated and individually extended from one end of the buffer strip 2. The first textile layer 2A at the end of the buffer strip 2 is affixed to the top end of the retaining strip 1. The second textile layer 2B at the end of the buffer strip 2 is affixed to the bottom end of the retaining strip 1. An opening separated by the first textile layer 2A and the second textile layer 2B at the buffer strip 2 faces toward the retaining strip 1, such that the retaining strip 1 and the buffer strip 2 can be overlappedly folded by sections as shown in FIG. 1. The folded retaining strip 1 and buffer strip 2 are received in a receiving pocket C, which is preferably made of plastic, to form a buffer pack. When a falling force is applied to the retaining strip 1, the retaining strip 1 and buffer strip 2 can be unfolded without interfering with each other. In particular, the falling force will tear the first textile layer 2A and second textile layer 2B away from each other to sequentially separate the first textile layer 2A and second textile layer 2B from one end of the retaining strip 1 to another end thereof as shown in FIGS. 3 and 4. In other words, the first textile layer 2A and second textile layer 2B will be unfastened with each other due to the falling force between the two ends of the buffer strip 2. In one embodiment, the tensile strength for resisting the tearing between the first textile layer 2A and second textile layer 2B is 200-300 kg*area, in which the tensile strength meets or slightly lower than the minimum standard of ANSI Z359.14 of the United States and EN360 of European Union besides the SRL-LE marginal test standard.

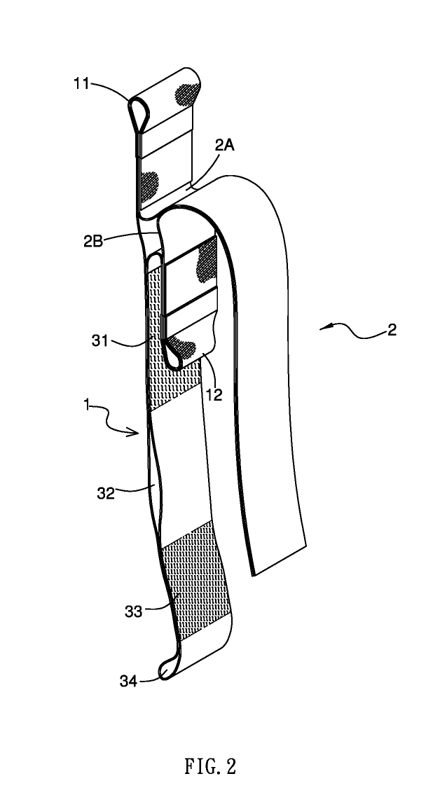

As shown in FIGS. 2 to 4, the compensating arrangement is provided at the folding section of the retaining strip 1, which refer to the retaining strip 1 being overlappedly folded from top to bottom or being overlappedly folded from bottom to top, wherein the compensating arrangement fastens the retaining strip 1 in a folded state in order to overlappedly fold the retaining strip 1 in sections. In particular, the compensating arrangement has a plurality of binding sections 31, 33 and a plurality of releasing sections 32, 34 alternating with the binding sections 31, 33. In other words, two first binding sections 31 are respectively provided at two ends of the retaining strip 1 close to the two ends of the buffer strip 2 and the releasing section 34 is provided at a mid-section of the retaining strip 1 away from two ends of the buffer strip 2. In one embodiment, a second releasing section 34 is provided between the two second binding sections 33, the two first binding sections 31 are provided at two ends of the retaining strip 1 respectively, and two first releasing sections 32 is respectively provided between the first binding section 31 and the second binding section 33. Accordingly, the releasing sections 32, 34 are the unfastening sections of the retaining strip 1 when the retaining strip 1 is folded, such that the releasing sections 32, 34 cannot compensate the tensile strength of the buffer strip 2 for resisting the tearing between the first textile layer 2A and the second textile layer 2B. The binding sections 31, 33 are fastening sections of the retaining strip 1 when the retaining strip 1 is folded, wherein the fastening sections of the retaining strip 1 are overlapped and affixed with each other via stitching to form a one piece attaching structure when the retaining strip 1 is folded. It is appreciated that the binding sections 31, 33 can be affixed via other affixing structure. The binding sections 31, 33 can sequentially compensate the tensile strength of the buffer strip 2 for resisting the tearing between the first textile layer 2A and the second textile layer 2B and can control the first releasing section 32 to enable to the retaining strip 1 to be unfolded, so as to provide a multistage buffering effect for the retaining strip 1 with the buffer strip 2. Therefore, the device according to the present invention will be able to meet the current standards of ANSI Z359.14 of the United States and EN360 of European Union and the requirements of the SRL-LE marginal test. According to actual testing, the tensile strength of the first binding section 31, i.e. the first binding section 31 close to the buffer strip 2, is weaker than the tensile strength of the second binding section 33, i.e. the first binding section 31 away from the buffer strip 2, and the tensile strength of the second binding section 33 is weaker than the tensile strength of the buffer strip 2. As a result, the safety protection function of the retaining strip 1 and the buffer strip 2 for coping with falling can be reinforced.

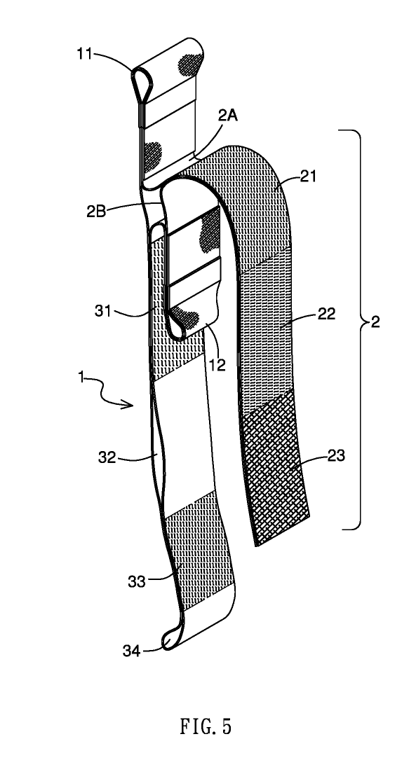

As shown in FIG. 5, the buffer strip 2 further has a first strip section 21, a second strip section 22, and a third strip section 23 sequentially defined between the two ends of the buffer strip 2. Accordingly, the first textile layer 2A and the second textile layer 2B are separated and individually extended from one end of the buffer strip 2 at the first strip section 21 thereof. The first textile layer 2A at the outer end of the first strip section 21 of the buffer strip 2 is affixed to the top end of the retaining strip 1. The second textile layer 2B at the outer end of the first strip section 21 of the buffer strip 2 is affixed to the bottom end of the retaining strip 1. The opening separated by the first textile layer 2A and the second textile layer 2B at the first strip section 21 of the buffer strip 2 faces toward the retaining strip 1. When a falling force is applied to the retaining strip 1, the retaining strip 1 and buffer strip 2 can be unfolded without interfering with each other. In particular, the falling force will tear the first textile layer 2A and second textile layer 2B away from each other to sequentially separate the first textile layer 2A and second textile layer 2B from the first strip section 21 through the second strip section 22 to the third strip section 23 as shown in FIG. 5. In other words, the first textile layer 2A and second textile layer 2B will be unfastened with each other due to the falling force along the first to third portions 21, 22, 23 of the buffer strip 2. The tensile strength of the first strip section 21 is greater than the tensile strength of the second strip section 22, and the tensile strength of the second strip section 22 is weaker than the tensile strength of the third strip section 23. Therefore, the present invention provides the multistage buffering effect to enhance the safety factor for the device.

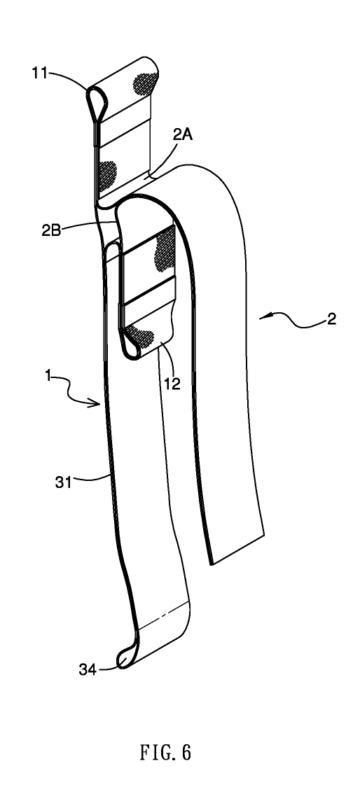

FIG. 6 further illustrates an alternative mode of the present invention, wherein the compensating arrangement only has one first binding section 31 provided at the retaining strip 1 from top to bottom. In particular, the retaining strip 1 is overlappedly folded, wherein the first binding section 31 has a plurality of horizontal stitches sequentially from top to bottom of the folded retaining strip 1. The intervals between every two adjacent stitches can be the same or different to overlappedly affix the retaining strip 1 in the folded state. The horizontal stitches can be sequentially broken to separate or unfold the folded retaining strip 1 in response to the falling force applied thereto. Therefore, the binding area 31 can

The horizontal stitches of the first binding section 31 can sequentially compensate the tensile strength of the buffer strip 2 for resisting the tearing between the first textile layer 2A and second textile layer 2B and can release the fastening of the retaining strip 1 to enable to the retaining strip 1 to be unfolded, so as to provide a multistage buffering effect for the retaining strip 1 with the buffer strip 2 without hurting the user's body.

To sum up, the present invention has the feature that the retaining strip 1 is incorporated with the buffer strip 2 to provide a multistage buffering configuration, so as to improve the cushioning and buffering function of the buffer strip 2. The feature and structure is completely new and novel to the prior arts and is an excellent and outstanding design. Besides, it has never been published or seen in the field of similar products, and therefore, meets the condition of patent application. Hence, it is submitted herein according to the law. However, the above descriptions are only a preferred embodiment of the present invention, but not to be used to confine the scope of embodying the present invention, which means all equivalent varieties and modifications based on the appended claims of the present invention are within the scope of the present invention.

One skilled in the art will understand that the embodiment of the present invention as shown in the drawings and described above is exemplary only and not intended to be limiting.

It will thus be seen that the objects of the present invention have been fully and effectively accomplished. The embodiments have been shown and described for the purposes of illustrating the functional and structural principles of the present invention and is subject to change without departure from such principles. Therefore, this invention includes all modifications encompassed within the spirit and scope of the following claims.

What is claimed is:

1. A fall protection and buffering device, comprising:
a retaining strip having a predetermined length between a top end and a bottom end thereof;
a buffer strip which comprises a first textile layer and a second textile layer overlappedly affixed with each other, wherein said first textile layer and said second textile layer are separated at one end of said buffer strip and are affixed to said top end and said bottom end of said retaining strip respectively, wherein an opening separated by said first textile layer and said second textile layer at said end of said buffer strip faces toward said retaining strip, such that said first textile layer and said second textile layer are torn from each other sequentially along said buffer strip in response to a falling force applied to said retaining strip; and
a compensating arrangement that fastens said retaining strip in a folded state, wherein said compensating arrangement has at least a binding section provided at said retaining strip to fasten said retaining strip in said folded state, such that said binding section compensates a tensile strength of said buffer strip for resisting a tearing between said first textile layer and said second textile layer.

2. The fall protection and buffering device, as recited in claim 1, wherein said compensating arrangement further has a releasing section provided at said retaining strip between two of said binding sections when more than one binding sections are provided, wherein a first binding section of said binding sections is provided at said retaining strip close to said buffer strip and a second binding section of said binding sections is provided at said retaining strip away from said buffer strip, wherein said releasing section is an unfastening section of said retaining strip when said retaining strip is folded, such that said releasing section has no compensation of said tensile strength of said buffer strip for resisting the tearing between said first textile layer and said second textile layer, wherein said binding sections are fastening sections of said retaining strip when said retaining strip is folded, wherein the fastening sections of the retaining strip are overlapped and affixed with each other, such that said binding sections sequentially compensate said tensile strength of said buffer strip for resisting the tearing between said first textile layer and said second textile layer so as to provide a multistage buffering effect for said retaining strip with said buffer strip.

3. The fall protection and buffering device, as recited in claim 1, wherein said compensating arrangement further has a plurality of releasing sections provided at said retaining strip and alternating with said binding sections when more than one binding sections are provided, wherein a first binding section of said binding sections is provided at said retaining strip close to said buffer strip and one of said releasing sections is provided at said retaining strip away from said buffer strip, wherein said releasing sections are unfastening sections of said retaining strip when said retaining strip is folded, such that said releasing sections have no compensation of said tensile strength of said buffer strip for resisting the tearing between said first textile layer and said second textile layer, wherein said binding sections are fastening sections of said retaining strip when said retaining strip is folded, wherein the fastening sections of the retaining strip are overlapped and affixed with each other, such that said binding sections sequentially compensate said tensile strength of said buffer strip for resisting the tearing between said first textile layer and said second textile layer.

4. The fall protection and buffering device, as recited in claim 2, wherein said tensile strength of said first binding section is weaker than said tensile strength of said second binding section, and said tensile strength of said second binding section is weaker than said tensile strength of said buffer strip.

5. The fall protection and buffering device, as recited in claim 3, wherein said tensile strength of said first binding section is weaker than said tensile strength of said second binding section, and said tensile strength of said second binding section is weaker than said tensile strength of said buffer strip.

6. The fall protection and buffering device, as recited in claim 1, wherein said buffer strip has a first strip section, a second strip section, and a third strip section sequentially defined between two ends of said buffer strip, wherein said first textile layer and said second textile layer are torn from each other sequentially along said first strip section, said second strip section, and said third strip section of said buffer strip in response to the falling force applied to said retaining strip, wherein said tensile strength of tearing said first textile layer and said second textile layer at said first strip section of said buffer strip is larger than said tensile strength of tearing said first textile layer and said second textile layer at said second strip section of said buffer strip, wherein said tensile strength of tearing said first textile layer and said second textile layer at said second strip section of said buffer strip is smaller than said tensile strength of tearing said first textile layer and said second textile layer at said third strip section of said buffer strip.

7. The fall protection and buffering device, as recited in claim 2, wherein said buffer strip has a first strip section, a second strip section, and a third strip section sequentially defined between two ends of said buffer strip, wherein said first textile layer and said second textile layer are torn from each other sequentially along said first strip section, said second strip section, and said third strip section of said buffer strip in response to the falling force applied to said retaining strip, wherein said tensile strength of tearing said first textile layer and said second textile layer at said first strip section of said buffer strip is larger than said tensile strength of tearing said first textile layer and said second textile layer at said second strip section of said buffer strip, wherein said tensile strength of tearing said first textile layer and said second textile layer at said second strip section of said buffer strip is smaller than said tensile strength of tearing said first textile layer and said second textile layer at said third strip section of said buffer strip.

8. The fall protection and buffering device, as recited in claim 3, wherein said buffer strip has a first strip section, a second strip section, and a third strip section sequentially defined between two ends of said buffer strip, wherein said first textile layer and said second textile layer are torn from each other sequentially along said first strip section, said second strip section, and said third strip section of said buffer strip in response to the falling force applied to said retaining strip, wherein said tensile strength of tearing said first textile layer and said second textile layer at said first strip section of said buffer strip is larger than said tensile strength of tearing said first textile layer and said second textile layer at said second strip section of said buffer strip, wherein said tensile strength of tearing said first textile layer and said second textile layer at said second strip section of said buffer strip is smaller than said tensile strength of tearing said first textile layer and said second textile layer at said third strip section of said buffer strip.

9. The fall protection and buffering device, as recited in claim 1, wherein said compensating arrangement further has a plurality of horizontal stitches formed at said retaining strip when said retaining strip is folded to define said binding section, wherein intervals between every two adjacent stitches are the same or different to overlappedly affix said retaining strip in said folded state.

10. The fall protection and buffering device, as recited in claim 2, wherein said compensating arrangement further has a plurality of horizontal stitches formed at said retaining strip when said retaining strip is folded to define said binding section, wherein intervals between every two adjacent stitches are the same or different to overlappedly affix said retaining strip in said folded state.

11. The fall protection and buffering device, as recited in claim 3, wherein said compensating arrangement further has a plurality of horizontal stitches formed at said retaining strip when said retaining strip is folded to define said binding section, wherein intervals between every two adjacent stitches are the same or different to overlappedly affix said retaining strip in said folded state.

12. The fall protection and buffering device, as recited in claim 1, further comprising a receiving pocket, wherein a length of said buffer strip is not longer than the length of said retaining strip, wherein said retaining strip and said buffer strip are overlappedly folded by sections and are received in said receiving pocket.

13. The fall protection and buffering device, as recited in claim 2, further comprising a receiving pocket, wherein a length of said buffer strip is not longer than the length of said retaining strip, wherein said retaining strip and said buffer strip are overlappedly folded by sections and are received in said receiving pocket.

14. The fall protection and buffering device, as recited in claim 3, further comprising a receiving pocket, wherein a length of said buffer strip is not longer than the length of said retaining strip, wherein said retaining strip and said buffer strip are overlappedly folded by sections and are received in said receiving pocket.

15. The fall protection and buffering device, as recited in claim 1, wherein said retaining strip comprises an upper connection unit extended from said top end and a lower connection unit extended from said bottom end.

16. The fall protection and buffering device, as recited in claim 2, wherein said retaining strip comprises an upper connection unit extended from said top end and a lower connection unit extended from said bottom end.

17. The fall protection and buffering device, as recited in claim 3, wherein said retaining strip comprises an upper connection unit extended from said top end and a lower connection unit extended from said bottom end.
